(19) United States
(12) Patent Application Publication
(10) Pub. No.: US 2006/0022065 A1
(43) Pub. Date: Feb. 2, 2006

(54) Distribution of air for carbon monoxide removal in a reformate

(76) Inventors: Mark R. Hagan, Houston, TX (US); Darryl Pollica, Melrose, MA (US); Ware Fuller, Acton, MA (US); Shane Magner, Belmont, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/533,369

(22) PCT Filed: Nov. 3, 2003
(86) PCT No.: PCT/US03/34978

§ 371 Date: Aug. 4, 2005

Related U.S. Application Data
(60) Provisional application No. 60/423,165, filed on Nov. 1, 2002.

(51) Int. Cl. F02M 45/10

(52) U.S. Cl. 239/93

(57) ABSTRACT

Several air inputs are typically required in removal of carbon monoxide from a fuel reformate, particularly when using the reformate in a PEM (polymer electrolyte membrane) fuel cell. Control can be greatly simplified by distributing the air or oxygen among the inlets in a fixed ratio using a fixed dimension flow path, such as sized orifices, conduits, and the like, and selecting the total oxygen input to the system based on the operating state of the system and its operating map.

### RELATED APPLICATIONS

This application claims priority of U.S. Provisional Application No. 60/423,165 filed Nov. 1, 2002, and claims priority of U.S. application Ser. No. 10/463,763 filed Jun. 13, 2003, both of which are related to U.S. Provisional Application No. 60/388,555 filed Jun. 13, 2002.

### TECHNICAL FIELD

The field of this invention relates to the distribution of oxygen or air to multiple inlets when removing carbon monoxide from a reformate stream that serves as the fuel stream for the anode of a fuel cell stack.

### BACKGROUND OF THE INVENTION

Reforming of hydrocarbon fuels to make hydrogen is well known in the art. In a first stage, hydrocarbons are reacted with steam to make a mixture of hydrogen, carbon dioxide, and other components, commonly referred to as reformate, sometimes also referred to as syngas, particularly before a water-gas shift reaction is performed. In a second stage, known as the water gas shift reaction, the reformate is treated with additional steam to convert most of the carbon monoxide to carbon dioxide and produce additional hydrogen. However, the shift reaction is an equilibrium reaction, and typically does not reduce the carbon monoxide content of the reformate to a level suitable for supplying to a PEM (polymer electrolyte membrane) fuel cell. For a PEM fuel cell, it is necessary to further remove carbon monoxide from the hydrogen rich reformate stream, so that the final level of CO (carbon monoxide) is below about 10 ppm. It is known to further reduce the carbon monoxide content of the hydrogen rich reformate exiting a shift reactor by preferential oxidation (“PrOx”) reaction (also known as “selective oxidation”) effected in a suitable PrOx reactor. A PrOx reactor usually comprises a catalyst that promotes the selective oxidation of carbon monoxide to carbon dioxide in the presence of oxygen and hydrogen, without oxidizing substantial quantities of the hydrogen itself.

The preferential oxidation reaction is:
CO+½O₂→CO₂

Desirably, the amount of O₂ used for the PrOx reaction will be no more than two times the stoichiometric amount required to react the CO in the reformate. If the amount of O₂ exceeds about two or three times the stoichiometric amount needed, excessive consumption of hydrogen results. On the other hand, if the amount of O₂ is substantially less than about two times the stoichiometric amount needed, insufficient CO oxidation may occur making the reformate unsuitable for use in a PEM fuel cell. The essence of the PrOx process is described in U.S. Pat. Nos. 1,366,176 and 1,375,932. Modern practice is also described, for example, in a “Preferential Oxidation of CO over Pt/γ-Al₂O₃ and Au/α-Fe₂O₃: Reactor Design Calculations and Experimental Results” by M. J. Kahlich, et al. published in the Journal of New Materials for Electrochemical Systems, 1988 (pp. 3946), and in U.S. Pat. No. 5,316,747 to Pow et al.

A wide variety of catalysts for promoting the PrOx reaction are known. Some are disclosed in the above references. In modern practice, such catalysts are often provided by commercial catalyst vendors and their compositions are typically proprietary. The practitioner is instead provided with approximate temperature ranges for use and some physical parameters. The properties of candidate catalysts have to be evaluated in the actual proposed design before the final selection of a catalyst for development or production. Moreover, catalysts come in a wide variety of physical forms. In addition to pellets and powders, which are typically porous to some extent, catalysts are also supplied on a large variety of supports. These may also be pellets but also include monoliths such as the ceramic and metal honeycombs used in automotive catalytic converters, metal, and ceramic foams, and other monolithic forms.

PrOx reactions are exothermic and may be controlled either adiabatically or isothermally. Adiabatic means that the temperature of the reformate and the catalyst are allowed to rise during the oxidation of carbon monoxide, while isothermal means that the temperature of the reformate and the catalyst are maintained constant during the oxidation of carbon monoxide. The adiabatic PrOx process is typically carried out in several stages, which progressively reduce the carbon monoxide content. Temperature control is important at all stages because if the temperature rises too much, methanation, hydrogen oxidation, or a reverse shift reaction can occur. The reverse shift reaction produces more carbon monoxide, which is undesirable, while methanation and hydrogen oxidation decrease system efficiencies.

The selectivity of the catalyst of the preferential oxidation reaction is dependent upon temperature, typically decreasing in selectivity as the temperature rises. The activity of the catalyst is also temperature dependent, increasing with higher temperatures. Furthermore, the reaction is very slow below a threshold temperature. For this reason, the temperature profile in a PrOx reactor is important in maximizing the oxidation of carbon monoxide while minimizing the undesirable oxidation of the hydrogen gas in the mixed gas stream.

More particularly, when the PrOx catalyst temperature is less than a certain value, high levels of CO may bind to the catalytic site but fail to react, thereby inhibiting the catalysts' performance. When the PrOx temperature increases beyond a certain point, catalyst selectivity decreases, which results in a higher equilibrium carbon monoxide concentration. Because of the multiple sensitivities of the reaction to temperature, there is for any catalyst a preferred temperature range for efficient operation. It is often desirable to perform a first step of the preferential oxidation at a higher temperature, for speed of reaction, and a final cleanup at a lower temperature, for selectivity and for minimum reverse shift.

In addition to temperature concerns, another concern is providing air to multiple inlets for CO removal. The PrOx reactor may have two, three, four or more stages of CO removal, in addition, air is sometimes added to the reformate as it enters the anode of the stack for removing CO that may have bound to the PEM membrane. See, e.g., U.S. Pat. No. 4,910,099 to Gottesfeld. The need for an airflow distribution and control adds numerous complexities to the system such as multiple air lines, air distributors, and air flow controllers, etc. For example, U.S. Pat. No. 5,637,415 to Meltzer et al. illustrates some of the complexities currently required for even a single air source. A system is needed for providing air to PrOx reactors and to the anode inlet that is efficient, simple, logical and inexpensive.

### BRIEF DESCRIPTION OF THE DRAWINGS

The following descriptions of the present invention are discussed with particular reference to the appended drawings of which:

FIG. 1 is a perspective view of a reformer system according to one embodiment of the present invention.

FIG. 2 is a cross sectional view of a PrOx reactor having multiple air inlets according to another embodiment of the present invention.

### SUMMARY OF THE INVENTION

According to one aspect of the invention, a method for distributing air in a carbon monoxide cleanup system in a fuel reformer is disclosed. The method comprises the steps of supplying air to a manifold, and supplying air from the manifold to each of two or more air inlet points in a carbon monoxide cleanup system. The method also comprises the steps of proportioning the air supplied amongst the air inlet points by providing a fixed dimension flow path from the manifold to each air inlet point, and varying the air supply to the manifold to correspond to a calculated level of carbon monoxide in a reformate. The method may further comprise pressurizing the air supply to the manifold with a pump. The calculation of air supply may be based on a system map relating an air supply level to a current mode of operation of the fuel reforming system. The air inlet points may comprise at least two air inlets into one or more preferential oxidation apparatuses. Preferably, the number of preferential oxidation apparatuses is from two through six. At least one of the air inlet points may supply air directly to a fuel cell anode. In one embodiment, the air supplied to one or more of the air inlet points can be shut off by a controller.

According to a further aspect of the invention, a system for distributing air for carbon monoxide clean-up comprises a manifold, and a fixed dimension flow path that connects the manifold to at least two air inlet points in a two stage preferential oxidation reactor (PrOx). A pump provides air to the manifold. A pump map determines an amount of air required for carbon monoxide cleanup for a given flow of fuel into the reformer. The pump map may also take into account variations in reformate flow and the corresponding expected variations of carbon monoxide concentration. Such a pump map can be determined empirically. In a preferred embodiment, a reformer reactor for making a reformate comprising carbon monoxide is connected to the PrOx. The manifold may be configured such that a certain percentage of air or flow is sent to a first air inlet in a first stage PrOx reactor, a certain percentage of air or flow is sent to a second air inlet in a second stage PrOx reactor, and the remainder of air is sent to an exit of the PrOx reactor or to an anode air bleed. The air supplied to one or more of the first stage of the PrOx reactor, the second stage of the PrOx reactor, and the exit of the PrOx reactor or to the anode air bleed can be shut off by a controller. One way to apportion air flow is by providing three fixed size orifices in either the manifold or the fixed dimension flow path. The orifices are sized to provide that about 70% of air flowing out of the manifold goes to the first stage PrOx reactor, about 20% goes to the second stage PrOx reactor, and about 10% goes to the PrOx exit or to the anode air bleed. By way of example, the orifice sizes may be 0.035″ for the first stage PrOx reactor, 0.016″ for the second stage PrOx reactor, and 0.011″ for the PrOx exit or the anode air bleed.

According to yet a further aspect of the invention, a system for distributing air flow for selective oxidation of a reformate comprises an air supply, and a reactor coupled to the air supply, the reactor having a first air inlet and a second air inlet, wherein the first air inlet and the second air inlet are sized to deliver air to the reactor in a fixed proportion. The air flow to the first air inlet and the second air inlet may be based on a calculation, the calculation being based on a system map relating to an air supply level corresponding to an amount of reformate generated by the reactor.

According to still a further aspect of the invention, a method for distributing air flow for selective oxidation of a reformate comprises the steps of supplying air to two or more air inlet points in a reactor, dividing the air supply amongst the air inlet points by sizing the air inlet points or conduits leading to those points, such that air is delivered in a desired fixed proportion, and varying the air supply to correspond to a calculated level of carbon monoxide in a reformate.

According to yet a further aspect of the invention, a system for distributing air flow for selective oxidation of a reformate comprises an air supply, and a fixed dimension flow path connected to the air supply for proportionately distributing the supplied air to a first reformer air inlet and a second reformer air inlet, the fixed dimension flow path being configured such that there is a fixed ratio between the volume of air sent to the first reformer air inlet and the volume of air sent to the second reformer air inlet, wherein the fixed ratio remains the same when the air pressure of the supplied air is varied according to a calculation based on a system map. The first reformer air inlet may provide air to a first reactor housing, and the second reformer air inlet may provide air to a second reactor housing. Alternatively, the first reformer air inlet and the second reformer air inlet may both provide air to a single reactor housing. Still alternatively, the first reformer air inlet may provide air to a reactor housing, and the second reformer air inlet, may provide air to an anode air bleed.

According to still a further aspect of the invention, a method for distributing air flow for selective oxidation of a reformate comprises the steps of supplying air to a reformer, and proportioning the amount of air supplied between a first reactor air inlet and a second reactor air inlet with a fixed dimension flow path, the fixed dimension flow path being configured such that there is a fixed ratio between the volume of air flowed through the path to the first reformer air inlet and the volume of air flowed through the path to the second reformer air inlet. The fixed ratio between the two flow paths remains the same when the air pressure of the supplied air is varied according to a calculation based on a system map.

### DETAILED DESCRIPTION OF THE PREFERRED EMBODIMENTS

While the invention is susceptible of embodiment in many different forms, there is shown in the drawings and will herein be described in detail preferred embodiments of the invention. It is to be understood that the present disclosure is to be considered as an exemplification of the principles of the invention. This disclosure is not intended to limit the broad aspect of the invention to the illustrated embodiments.

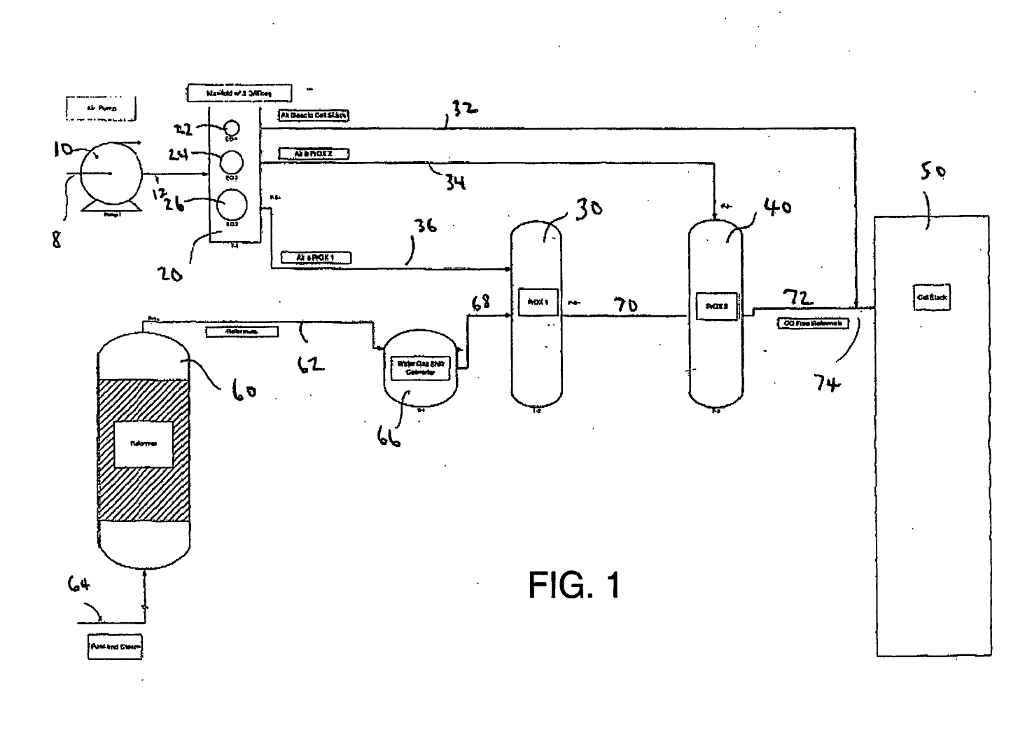

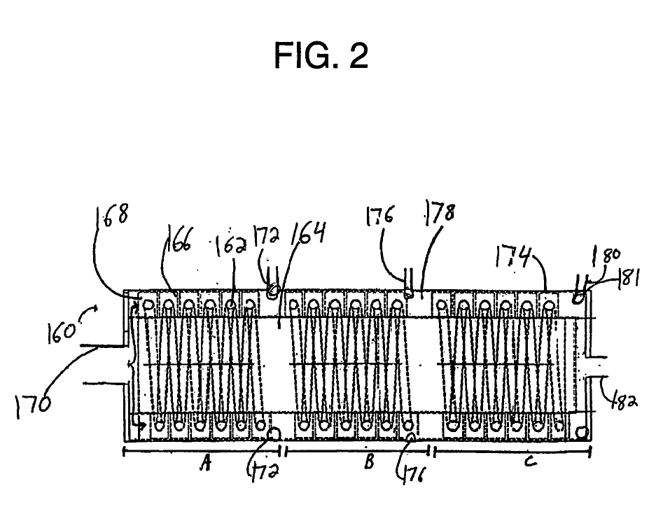

FIG. 1 contains a schematic of one embodiment of the invention comprising fixed dimension flow path that is used to proportionately distribute air to a plurality of PrOx stages and/or to an anode air bleed to optimize CO removal from a reformate, while avoiding excessive hydrogen consumption. To achieve a fixed dimension flow path, calibrated orifices may be employed at the beginning of the flow path, the end of the flow path, or anywhere in between. Alternatively, the fixed dimension flow path may use various conduit diameters, conduit lengths, calibrated pinched areas in the conduits, or the like to provide the fixed proportion of air flow for the conduit relative to conduits supplying air to other inlets. The fixed dimension flow path may use any or all of the aforementioned mechanisms to proportion the air, the point being that the path is fixed. In other words, no part of the flow path needs to be adjusted when more or less reformate is present in the reformer system. According to a broad aspect of the invention, it does not matter whether the PrOx stages or air inlet points are housed in separate reactor housings, as shown in FIG. 1, or in a single reactor housing, as shown in FIG. 2, or incorporate a combination of these arrangements.

In FIG. 1, a fixed dimension flow path includes a plurality of calibrated orifices 22, 24, and 26 in a manifold 20 that proportionately distribute air to a first stage PrOx 30, a second stage PrOx 40, and the exit of the PrOx at 74 to be used as an air bleed to the anode of the fuel cell stack 50. The manifold 20 could be a plenum or any other device that can distribute air to multiple conduits. An air pump 10 pressurizes air from a source 8 through a line 12 to the manifold 20 fitted with the three orifices 22, 24, and 26. It is important to note that the manifold 20 may have any number of orifices. For example, the manifold 20 may have two, three, four, five, or more orifices as dictated by each system's oxygen needs.

In FIG. 1, the largest orifice 26 provides air through a line 36 to stage one of the PrOx 30. The next largest orifice 24 provides air through a line 34 to stage two of the PrOx 40. The smallest orifice 22 provides air through a line 32 to an anode inlet air bleed 74. Fuel and steam, and in some cases air are supplied through a line 64 to a reformer 60 to make a reformate, which reformate contains carbon monoxide. The reformer 60 may be a steam reformer, an autothermal reformer, or a partial oxidation reformer. The reformate passes through a line 62 to a water gas shift reactor 66, where most of the carbon monoxide produced in the reformer 60 is converted to carbon dioxide and hydrogen. The reformate then passes through a line 68 to the first stage of the PrOx 30, where some of the residual CO is converted to carbon dioxide. The reformate then passes through a line 70 to the second stage PrOx 40, where most of the residual CO is converted. The reformate leaves the PrOx 40 through a line 72 and mixes at point 74 with additional air from the orifice 22, just before entering the fuel cell stack 50.

The details for how many stages of PrOx to provide, and the relative distribution of air to the stages that is required, depends on the detail of the design of the reforming system. In one embodiment, about 70% of the air flow is sent to the inlet of stage one of the PrOx 30, about 20% is sent to the inlet of stage two of the PrOx 40, and about 10% is sent to the exit of the PrOx at 74 to be used as an air bleed for the anode of the fuel cell stack 50. The desired orifice sizes, in the embodiments above for a particular flow rate, are 0.035″ for the PrOx inlet, 0.016″ for the stage two inlet, and 0.011″ for the PrOx exit. The air flow is proportional to the area of the orifices, and thus the relative cross-sectional areas of these orifices could be used with orifices of different sizes to provide higher or lower air flows at the same proportions. Suitable orifices with other dimensions, and with other area ratios may be utilized depending on the requirements of the particular reformer system. Orifices of various sizes are commonly sold for use in furnace systems. Such orifices can be used in the present invention if they are the correct size. Otherwise, the orifices can be machined to meet the needs of the particular reformer system. It should be noted that the fixed proportioning orifices do not have to be housed in the manifold, but can be housed at any suitable location in the system from the manifold to the inlet point of the reactors or reactor feed lines.

The use of fixed proportioning orifices or other fixed proportioning conduits greatly simplifies control of the PrOx reaction. Rather than having several valves, plus control lines, sensors, and decision programs in the system controller, only one control is required for the total amount of air to be supplied to the manifold for CO removal. This can be supplied by regulation of a compressor or blower, as illustrated, or by a control valve and pressure sensor operating out of a system air manifold that supplies air for additional reformer functions. A regulator or controller may be used to shut off the air supply to one or more areas of the system, i.e., to the second PrOx stage, when oxygen demands are low or oxygen is not needed at all in that area.

The total air flow to the PrOx and anode air bleed may be controlled through the use of a system map (for example, a look-up table) that takes into account how much air is required for the CO cleanup for a given flow of fuel into the reformer. Such a system map is typically determined empirically, for example by measuring CO output of the reformer, before and after the PrOx stage or stages, at various conditions of operation of the system. This map can take into account both an increase and a decrease in reformate flow, as well as any increase in the CO concentration in the reformate as fuel input to the system is increased.

Based on such calculations and standards, in actual operation a CO sensor is not necessarily required. In such a case, air flow may be metered without the use of a flow sensor to provide feedback, which further simplifies the system. To meter the air flow, a strictly proportional pump, such as a diaphragm pump with consistent pressure/flow/speed curves, is preferably used, so that air flow measurement and/or downstream pressure measurement is also not required. Therefore, a voltage is sent to the pump that is internally used to control the speed of the pump and this same voltage is empirically mapped to the flow produced when the pump is used in the system. Thus, an overall map of a conversion of system fuel input to CO cleanup air pump voltage may be created. The end product is a system that efficiently controls CO removal in a multi-stage process that requires only regulation of total air input to the final CO removal system, based on the operating state of the system via a system map.

Alternative embodiments, not shown, have three or more stages of air inlet to the PrOx reaction; or have the final air bleed occur in the fuel cell stack, or inside the second PrOx stage. Alternative embodiments also have subsidiary air distribution within one or more single PrOx stages or housings. The various PrOx stages may have different air bleeds in the same device, or may have air bleeds or inputs into separate housings there the PrOx is carried out in separate housings.

FIG. 2 shows another embodiment of the present invention wherein there are multiple air inlets 170, 172, and 176 supplying air to a single housing PrOx reactor 160. PrOx reactor 160 includes the use of a two phase water cooling system. The water/steam is contained within a helical tube 162. Here, the helical tube 162 coils around a central core 164 that is a hollow space contained within a chamber.

In other embodiments, the core 164 may contain an insulating material, a heat exchanger, or another reforming reactor module for preparation of a hydrocarbon fuel for use in a PEM fuel cell. In one embodiment, the reforming reactor module includes a Low Temperature Shift (LTS) module located in the core 164. A LTS module is preferred in that it is temperature compatible with a PrOx reactor, and additionally, the reformate can easily be routed directly from the LTS module to an inlet of a PrOx reactor.

The reactor has a first inlet 170 to which air and reformate having a temperature typically within the range of from about 250° C. to about 350° C. are supplied. The helical tube 162 is typically constructed of copper or stainless steel. The helical tube 162 is surrounded by fins 166 creating a first tube/fin assembly 168. Additional tube/fin assemblies may be provided. The fins 166 are preferably constructed of a corrosion resistant material capable of withstanding the operating temperatures of the system. The preferred shapes for the fins 166 are square or rectangular, although other shapes could easily be substituted. The number of fins 166 in this embodiment is sixteen per inch, although a lesser or greater number could be substituted as desired depending on the details of the system design. The fins 166 are preferably affixed to the tube/fin assembly 168. This may be done by silver soldering, nickel brazing, or press fitting the fins onto the tubes, with or without flanges or washers, to affix the fins 166 in place. The tube/fin assembly 168 may be treated to prevent corrosion, for example, by plating with nickel or other corrosion-resistant material.

Any or all of the fins and tubing may be wash-coated with a PrOx catalyst. As discussed above, many suitable catalysts exist for performing the PrOx reaction. It is preferred that a catalyst which displays optimal activity and selectivity for reacting CO without substantially reacting hydrogen throughout the operating temperature range is selected. A typical catalyst is a group VIII metal, or sometimes a Group VIB or VIIB metal, usually with selectivity promoters based on non-noble metals or metal oxides.

In this embodiment, the helical tube 162 and the fins 166 are contained between a cylindrical outer tube 174 and cylindrical inner core 164 which are concentrically arranged. Moving axially down the passage 178 formed between the outer tube 174 and inner core 164, the reactor of this embodiment contains three sections A, B, and C. Reformate and oxygen enter section A through the first inlet 170, where they are cooled by passing over the helical tube 162 which contains two phase water/steam. The temperature of the reformate is lowered to be in the range of from about 100° C. to about 200° C. Section A of the reactor 160 does not include catalyst. Passing through section A lowers the temperature of the reformate to a temperature more favorable for the selective oxidation reaction.

The tube/fin assembly 168 within section B of the reactor 160 is wash-coated with a selective oxidation catalyst. The wash-coating embodiment of this embodiment is preferred in many cases, especially mobile applications, because it is more durable and resistant to attrition than pellets. Moreover, the catalyst will operate at a temperature very close to that of the coolant, improving control of reaction temperatures. However, other physical forms of the catalyst may also be used, particularly catalyst-coated foams or monoliths, or even pellets with some redesign.

Air may also be added at a second inlet 172 to facilitate the exothermic selective oxidation of the reformate in section B, which raises the temperature of the reformate. The helical tube 162 absorbs heat, and within the tube 162 water is vaporized to steam. The temperature of the helical tube 162 (and of the enclosing fins 166) remains substantially constant where the two phase system is maintained. The boiling point of the water is dependent on pressure, and the temperature of the steam/water mixture is maintained at the boiling temperature as long as the two phases are present. The operating pressure within the helical tube 162 is generally maintained within the range of from about 1 atmosphere to about 10 atmospheres. The pressure within the tube remains essentially constant and is controlled by an external pressure regulating device, such as a variable speed or pressure pump, a regulator valve, an orifice, or functionally similar known devices. Preferably, the cooling water is maintained as a one phase liquid, or a two phase liquid/vapor system substantially throughout at least sections B and C of the reactor 160.

Additional air may be added at a third inlet 176, and further selective oxidation of the reformate occurs in section C of the reactor 160. The amount of air added through the third inlet 176 is typically 10% to 30% of the total air introduced into the system, more preferably, about 20%. The second and third air inlets 172 and 176 preferably inject the air through tubes having a plurality of holes facing in a direction countercurrent to the flow of reformate to improve mixing. Mixing may be enhanced if required throughout the reactor by the provision of mixing chambers, turbulence-creating devices, diffusing beds, and other known means. According to the invention, the size and number of these holes may be differed among the inlets 170, 172 and 176 to provide the proportionality in the fixed dimension flow path.

The specific location of the air inlets may differ for other embodiments. Also, more or less air inlets may be used in a reactor. The temperature of the reformate increases upon the selective oxidation caused by the second addition of oxygen. In other embodiments, no additional air is added, and the temperature of the reformate continues to decrease as it moves through the reactor. While FIG. 2 shows a reactor having multiple air inlets 170, 172, and 176, other embodiments may include more or less than three air inlets, or may include air bleeds. A final air bleed may be provided through inlet 180 and injector of distributor 181, proximate to the outlet 182. This air is conveyed to a fuel cell downstream from a PrOx, where it oxidizes any CO adsorbed to the fuel cell membrane catalysts.

The total amount of oxygen added to the system is controlled by a single controller (not shown) in response to the level of CO predicted by a system map of the reformer, or a measured value. In those embodiments having multiple oxygen feeds, the oxygen can be drawn from a common source and distributed among the various feeds as a proportion of the whole. This may be done by sizing the air inlets to deliver air to the PrOx reactor in a fixed proportion. This may also be accomplished using calibrated orifices, as described above, which deliver a fixed fraction of the total oxygen supply to each air inlet. The total air supply to the inlets or orifices is based on a calculation. The calculation is based on a system map relating to an air supply level that corresponds to an amount of reformate in the PrOx reactor. Additionally, the controller may be used to shut off the air supply to one or more areas of the system, if oxygen demands in that area of the system are low or non-existent, as described above.

The rate of water fed to the helical tube 162 is controlled to maintain a water/steam two phase system through at least reactor 160 sections C and a substantial portion of B. In this way, the boiling temperature of water, at the system pressure of the water, controls the temperature profile of the principal reaction portion of the PrOx catalyst, and of the reformate flowing over it, so as to maintain the temperature in the optimal operating range of the particular catalyst being used. While the flow rate is adjusted as needed, it is generally possible to maintain the flow rate at a constant level through a wide range of operating conditions, including varying system demands. The presence of two phase water makes the system resilient to transient power demands. The point within the helical tube 162 at which the system becomes a two phase system may vary substantially throughout the length of the reactor 160, particularly within sections A and B, with little effect on the final level of CO in the reformate, as long as at least part of the length contains the two phase water/steam mixture. The operating temperature of the reactor varies with position within the reactor.

While the specific embodiments have been illustrated and described, numerous modifications come to mind without significantly departing from the spirit of the invention, and the scope of protection is only limited by the scope of the accompanying claims.

What is claimed is:

1. A method for distributing air in a carbon monoxide cleanup system in a fuel reformer, the method comprising the steps of:
supplying air to a manifold;
supplying air from the manifold to each of two or more air inlet points in a carbon monoxide cleanup system;
proportioning the air supplied amongst the air inlet points by providing a fixed dimension flow path from the manifold to each air inlet point; and,
varying the air supply to the manifold to correspond to a calculated level of carbon monoxide in a reformate.

2. The method of claim 1 further comprising providing the air supply to the manifold with a pump and the pump characteristics are taken into account in varying the air supply to the manifold.

3. The method of claim 1 wherein the calculation of air supply is based on a system map relating an air supply level to a current mode of operation of the fuel reforming system.

4. The method of claim 1 wherein the air inlet points comprise at least two air inlets into one or more preferential oxidation apparatuses.

5. The method of claim 4 wherein the number of preferential oxidation apparatuses is selected from the numbers two through six.

6. The method of claim 1 wherein at least one of the air inlet points is supplying air to a fuel cell anode.

7. The method of claim 1 wherein the air supplied to one or more of the air inlet points can be shut off by a controller.

8. A system for distributing air for carbon monoxide clean-up comprising:
a manifold,
a fixed dimension flow path that connects the manifold to at least two air inlet points in a two stage preferential oxidation reactor (PrOx);
a pump which provides air to the manifold;
a pump map that determines an amount of air required for carbon monoxide cleanup for a given flow of fuel into the reformer, wherein the pump map takes into account the increase in reformate flow and the increase of carbon monoxide concentration, and wherein the pump map is determined empirically; and,
a reformer reactor connected to the PrOx, the reformer reactor for making a reformate, the reformate comprising carbon monoxide.

9. The system of claim 8 wherein the manifold is configured such that a certain percentage of air is sent to a first air inlet in a first stage PrOx reactor, a certain percentage of air is sent to a second air inlet in a second stage PrOx reactor, and the remainder of air is sent to an exit of the PrOx reactor or to an anode air bleed.

10. The system of claim 9 wherein the air supplied to one or more of the first stage of the PrOx reactor, the second stage of the PrOx reactor, and the exit of the PrOx reactor or to the anode air bleed can be shut off by a controller.

11. The system of claim 9 further comprising:
three fixed size orifices in the manifold or the fixed dimension flow path, the orifices being sized to provide that about 70% of air flowing out of the manifold goes to the first stage PrOx reactor, about 20% goes to the second stage PrOx reactor, and about 10% goes to the PrOx exit or to the anode air bleed.

12. The system of claim 11 wherein the orifice sizes are 0.035″ for the first stage PrOx reactor, 0.016″ for the second stage PrOx reactor, and 0.011″ for the PrOx exit or the anode air bleed.

13. A system for distributing air flow for selective oxidation of a reformate comprising:
an air supply; and,
a reactor coupled to the air supply, the reactor having a first air inlet and a second air inlet, wherein the first air inlet and the second air inlet are sized to deliver air to the reactor in a fixed proportion.

14. The system of claim 13 wherein the air flow to the first air inlet and the second air inlet is based on a calculation, the calculation being based on a system map relating to an air supply level corresponding to an amount of reformate in the reactor.

15. The system of claim 13 wherein the air flow supplied to one or more of the first air inlet and the second air inlet can be shut off by a controller.

16. A method for distributing air flow for selective oxidation of a reformate, the method comprising the steps of:
supplying air to two or more air inlet points in a reactor;
dividing the air supply amongst the air inlet points by sizing the air inlet points such that air is delivered in a desired fixed proportion; and,
varying the air supply to correspond to a calculated level of carbon monoxide in a reformate.

17. A system for distributing air flow for selective oxidation of a reformate comprising:
an air supply; and,
a fixed dimension flow path connected to the air supply for proportionately distributing the supplied air to a first reformer air inlet and a second reformer air inlet, the fixed dimension flow path being configured such that there is a fixed ratio between the volume of air sent to the first reformer air inlet and the volume of air sent to the second reformer air inlet, wherein the fixed ratio remains the same when the air pressure of the supplied air is varied according to a calculation based on a system map.

18. The system of claim 17 wherein the first reformer air inlet provides air to a first reactor housing, and the second reformer air inlet provides air to a second reactor housing.

19. The system of claim 17 wherein the first reformer air inlet and the second reformer air inlet both provide air to a single reactor housing.

20. The system of claim 17 wherein the first reformer air inlet provides air to a reactor housing, and the second reformer air inlet provides air to an anode air bleed.

21. A method for distributing air flow for selective oxidation of a reformate, the method comprising the steps of:
supplying air to a reformer; and,
proportioning the supplied between a first reformer air inlet and a second reformer air inlet with a fixed dimension flow path, the fixed dimension flow path being configured such that there is a fixed ratio between the volume of air sent to the first reformer air inlet and the volume of air sent to the second reformer air inlet, wherein the fixed ratio remains the same when the air pressure of the supplied air is varied according to a calculation based on a system map.
